(19) United States
(12) Patent Application Publication
(10) Pub. No.: US 2024/0004038 A1
(43) Pub. Date: Jan. 4, 2024

(54) LASER SCANNER

(71) Applicant: ZOLLER & FRÖHLICH GMBH, Wangen im Allgäu (DE)

(72) Inventors: Markus Mettenleiter, Isny (DE); Christoph Fröhlich, Wangen (DE)

(21) Appl. No.: 18/038,063

(22) PCT Filed: Nov. 25, 2021
(86) PCT No.: PCT/EP2021/083010

§ 371 Date: May 25, 2023

(30) Foreign Application Priority Data
Nov. 26, 2020 (DE) 102020131412.4

(51) Int. Cl. G01S 7/481

(52) U.S. Cl. CPC G01S 7/4817; G01S 7/4813

(57) ABSTRACT

A laser scanner includes a laser head for emitting a measurement beam of a rotating deflection unit driven for deflecting the measurement beam in the direction of a measuring object. The scanner further includes a detector module for detecting the reception/measurement beam reflected by the measuring object, and a control and evaluation unit for signal processing. The deflection unit has a hollow spindle, which carries a beam guide to which a deflection mirror is associated for deflecting the reception/measurement beam in the direction of or from an outlet window held on a rotor housing. At least one pocket is formed on the beam guide, which is aligned in such a way that the deflection mirror is fixed to the beam guide or to the hollow spindle.

### CROSS REFERENCE TO RELATED APPLICATIONS

The present patent application is a national stage of, and claims priority to, PCT Application No. PCT/EP2021/083010, filed Nov. 25, 2021, which application claims the priority of the German patent application 10 2020 131 412.4 filed on Nov. 26, 2020, the contents of each of which are incorporated by reference in their entireties into the subject matter of the present patent application.

### TECHNICAL FIELD

The present disclosure relates to a laser scanner in accordance with the preamble of an independent claim.

### BACKGROUND

From the prior art, scanners for 3D and 2D measurement of objects are known.

3D measurement is carried out, for example, by means of a scanner, as described in Applicant's patent DE 101 50 436 B4. A further improved 3D laser scanner is disclosed in DE 10 2016 119 155 A1, which likewise is attributable to Applicant. In such a scanner the laser beam emitted by an optical transmitter is deflected by a deflection unit such that comprehensive three-dimensional spatial measurement of the environment is made possible. The digitized measurement data is stored in a computer system, where it is available for further processing and visualization of the measured object.

3D measurement is executed by guiding the modeled laser light over the environment to be measured, whereby both the distance and the reflectivity value can be measured point by point for different spatial directions. The arrangement of all measured spatial directions then results in distance and reflectivity images. The distance images reproduce the geometry of the environment and the reflectivity images their visual images, analogous to the gray-scale values of a video camera. Both images correspond pixel by pixel and are, due to an autonomous, active illumination with laser light, largely independent of environmental influences.

For 2D measurement scanners are used, for example, as are offered by Applicant under the name “Profiler”® 9012. With such a scanner, a 360° profile measurement is performed by rotating the deflection mirror of a deflection unit, the rotational speed of the deflection mirror determining the number of profiles to be measured per second, each of these 360° profiles consisting of individual measuring points that correspond to the scan rate of the scanner.

Area-wide coverage, for example when surveying contact wires, buildings close to a track, tunnel tubes or during mobile mapping, is achieved by measuring the profile while driving through the surrounding area, with the profile being recorded perpendicular to the direction of travel. The locally successive profiles (helix) are arranged to form an image, whereby the lateral distance between two profiles can be varied depending on the speed of the carrier vehicle. In the process, the carrier vehicles move at relatively high speeds up to the range of 100 km/h.

The aforementioned “profiler” has a stepped housing in which the components of the scanner, such as, for example, a laser head, a detector/receiver, a control and an evaluation unit are accommodated. The deflection unit and the associated drive essentially are arranged in the area of a step outside the housing, the deflection unit protruding from the housing to such an extent that the aforementioned 360° measurement is possible. The scanner with its comparatively tall housing is mounted on the carrier vehicle and thus is exposed to airstream and other environmental influences.

In post-published DE 10 2020 127 350.9, a further development of the aforementioned profiler is described in which the housing is much more compact and in addition, the reference module is integrated in the housing.

The problem with such scanners is that the deflection mirror is mounted on the bottom of a rotor housing, which surrounds the aforementioned beam line outwardly. To clean the outlet window, the rotor case then must be removed, so that the relative positioning of the deflection mirror with respect to the beam line changes, so that new scanner calibration is required.

Another disadvantage of conventional 2D scanners is that the attachment of the rotor housing to the hollow spindle requires a rather massive construction, the exact positioning of the deflection mirror depending on the transitions between the hollow shaft, the rotor housing and the deflection mirror. As set forth above, this relative positioning changes when the rotor housing is dismantled. In addition, the connection between the deflection mirror and the hollow spindle can deform dynamically under extreme centrifugal forces or temperature fluctuations.

### SUMMARY

In contrast, the present disclosure is based on the problem of creating a laser scanner which can be cleaned in a simple manner without affecting measurement accuracy and in which an influence of stray light is minimized.

This problem is solved by a laser scanner including the features of an independent claim.

Advantageous further developments of the disclosure are subject of the dependent claims.

The laser scanner in accordance with the disclosure is designed with a laser head for emitting a measurement beam, a rotating deflection unit driven by way of a drive for deflecting the measurement beam in the direction of a measuring object, a detector module for detecting the receiving/measurement beam reflected by the measuring object, and a control and evaluation unit for signal processing. The deflection unit has a hollow spindle, which carries a beam guide, to which a deflection mirror is associated for deflecting the receiving/measurement beam in the direction of or from a protective glass (aperture glass) covering the outlet window. According to the disclosure, the deflection mirror is not, as in the prior art, mounted on a rotor housing surrounding at least part of the beam guide, but directly on the beam guide, or the hollow spindle, so that for cleaning the outlet window the rotor housing is removed or opened, whereby the position of the deflection mirror relative to the beam guide remains unchanged.

In one alternative, the deflection mirror is positioned between the beam guide and a counterweight, which is connected to the beam guide. In this way, an optimal positional fixation of the deflection mirror in terms of the device is ensured, since in principle no additional fastening means need to be provided.

It is particularly preferred that the fasteners of the counterweight, for example screws or dowel pins, pass through the deflection mirror.

The beam guide is further optimized if the deflection mirror is positioned on an inclined end face of the beam guide.

The structure of the scanner is particularly simple if the rotor housing encompasses the deflection mirror, the beam guide and the counterweight at least in sections and is attached to a front flange of the hollow spindle.

The counterweight and the beam guide are plate- or web-shaped in order to minimize the rotating masses.

A front flange of the hollow spindle can be provided with drive means, preferably a toothed rim.

To minimize the influence of stray light, at least one pocket can be formed on the beam guide, which is aligned so that portions of the measurement beam (stray light) reflected by the protective glass are deflected via the deflection mirror in the direction of the pocket. This at least one pocket is designed so as to be able to “catch” the stray light, so that it “tails off” so to speak within the pocket and cannot falsify the measurement result. The geometry of the pockets is optimized accordingly. In principle, the term “pocket” can be understood to mean a geometric design of the beam guide such that it is not required for guidance of the actual measurement beam, but forms recesses arranged laterally of the outgoing measurement beam path, which are located in the beam path of stray light. These pockets/recesses can be, for example, radial extensions of the beam guide, whereby the pockets may extend, for instance, in the direction of the deflection mirror and/or towards the hollow spindle.

The reduction of stray light can be improved further if these pockets are provided with a reflection-reducing coating. This coating may contain, for example, a black anti-reflective coating.

In one example, the deflection mirror is located between a counterweight and the beam guide. In such an example it is preferred if these pockets open into an inclined end face of the beam guide.

The manufacturing effort required to produce the beam guide is minimal, if these pockets/recesses open into a screw bore, into which screws/fasteners can be inserted that are required for fastening the beam guide to the hollow spindle or for fastening an end flange terminating an end face of the hollow spindle. Of course, instead of such screws, also dowel pins or the like can be inserted in the “screw holes”.

Cleaning of the laser scanner is particularly easy if the deflection mirror, as explained above, is located between the beam guide and the counterweight, so that, for example, a rotor housing with an outlet window can be removed without changing the position of the deflection mirror.

In such a case, the rotor housing, for example, can encompass the deflection mirror, the beam guide and the counterweight at least in sections and can be attached to a front flange of the hollow spindle.

The rotating masses of the deflection unit are particularly low if the counterweight and the beam guide are executed in the form of a plate/web. The structure is simplified further if the aforementioned front flange carries drive means, e.g., a toothed rim of a belt drive.

In a further development of the disclosure, a seal is arranged in the region between the outlet window and the beam guide, along which the outlet window rests. The seal also helps to reduce stray light.

To minimize the mass moment of inertia of the rotating deflection unit the deflection mirror is made of a material with a lower specific weight than aluminum. Preferably, the deflection mirror is made of silicon carbide.

### BRIEF DESCRIPTION OF THE DRAWINGS

Preferred examples of the disclosure are explained in more detail below with the aid of schematic drawings, of which

FIG. 1 is a three-dimensional representation of a 2D laser scanner in accordance with the disclosure;

FIG. 2 is a side view of the laser scanner according to FIG. 1;

FIG. 3 is a view of the laser scanner with the housing open, the individual components being illustrated only schematically;

FIG. 4 is an external view of a hollow spindle of the laser scanner according to FIGS. 1 to 3;

FIG. 5 is a section through the hollow spindle according to FIG. 4;

FIG. 6 is a partial front view of the deflection unit and

FIG. 7 is a partial representation of the deflection unit according to FIG. 5.

### DESCRIPTION

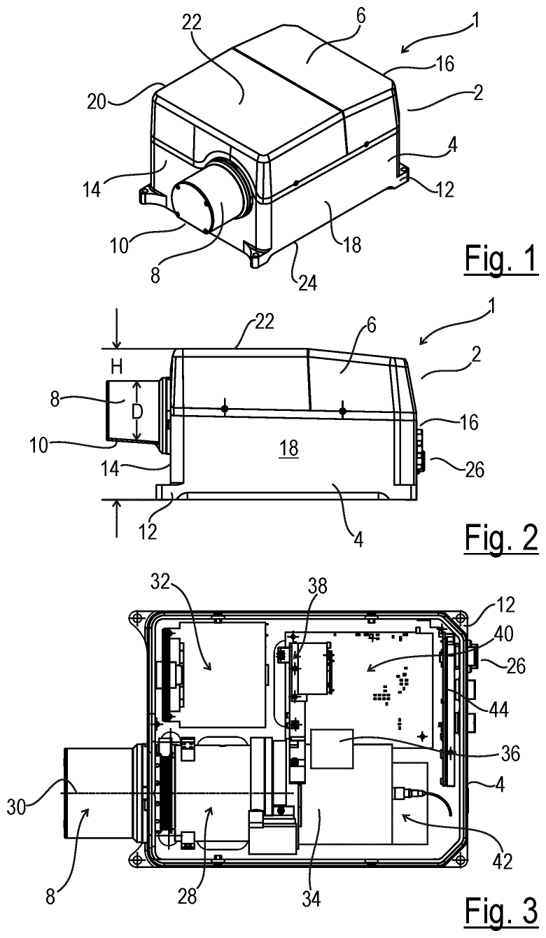

FIGS. 1 and 2 show external views of a 2D laser scanner 1 in accordance with the disclosure, which enables the measurement of 360° profiles. The laser scanner 1 has an approximately cuboidal housing 2 with a lower housing part 4 and a housing cover 6, which is placed on the lower housing part 4. A deflection unit 8 in the form of a rotor protrudes from the end face of housing 2, and on its flat bottom portion 10, as shown in FIG. 1, an outlet window for a measurement beam is formed. The deflection unit 8 rotates about a horizontal axis, so that a 360° profile can be scanned via the measurement beam. On lower housing part 4 support feet 12 (only one being marked with a reference symbol) are formed, along which the laser scanner 1 is mounted on a carrier, e.g. a carrier vehicle.

As can be seen in particular from FIG. 1, the housing 2 in the broadest sense is formed as a smooth surface with rounded edges and corner areas, so that the air resistance is minimal. Vis-à-vis the solutions known from the prior art the housing is executed in a clearly flatter manner, the end faces 14, 16 being exposed to the airstream when the carrier vehicle is moving (in most cases the laser scanner 1 with the deflection unit 8 is oriented in the opposite direction to the direction of travel, so that the opposite end face 16 is exposed to the airflow). The two end faces 14, 16 have a smaller surface area than the lateral surfaces 18, 20, which are arranged approximately at right angles thereto, and base areas 22, 24.

FIG. 2 shows a lateral view of the laser scanner 1, in which the lateral surface 18 is arranged towards an observer, while the end faces 14, 16 are perpendicular to the drawing plane. In this illustration, connections 26 formed on the rear end face 16 are to be seen via which the power supply and signal lines etc. are connected.

For further minimizing flow resistance, the end surface sections formed on housing cover 6 are slightly beveled. Moreover, base area 22 is executed to slope toward the connections 26. Accordingly, the housing is optimized fluidically by the smooth-surfaced design and rounding of the corner areas 34 as well as chamfering of the end surface areas, so that any impairment of the measuring accuracy by airstream or other environmental influences is minimized.

As explained above, the housing 2 is designed in a very flat manner. In the described example, the overall height H of the housing is approximately twice the diameter D of the deflection unit 8, i.e., the projection of the housing 2 in the vertical direction over the rotating deflection unit 8 is minimal.

FIG. 3 shows a top view of the housing 2 with the housing cover 6 removed, providing a view into the interior of the lower housing part 4. The components visible in FIG. 3 are merely implied. They are arranged more or less in a horizontal plane next to each other or at most slightly overlapping in the vertical direction. FIG. 3 shows a spindle 28, which carries the rotating deflection unit 8 and which is mounted in the housing 2 so as to be rotatable about the axis of rotation 30. Driving is performed via a motor 32, which is operatively connected to the spindle 28, for example via a toothed belt or the like.

The spindle 28 is executed as a hollow spindle, in the interior of which the beam path is formed in sections. Aligned to the axis of rotation 30 or to the beam path, a laser head 34 is arranged in the housing 2, to which a laser fiber is connected, via which the measurement beam is coupled into laser head 34 by means of a collimator. The measurement beam emitted by this emitter/laser head 34 is emitted through a parabolic mirror in the direction of the deflection unit 30 in which a deflection mirror 46 arranged at 450 to the axis of rotation 30 is held via which the measurement beam is deflected towards the outlet window which, in the case of the example shown, is covered by a protective glass/aperture glass. The structure of such a deflection unit is described in the prior art mentioned at the beginning, in particular in patent DE 101 50 436 B4 of Applicant. The structure of the concave mirror of the laser head 34 is described, for example, in DE 10 2006 040 812 A1, which likewise goes back to Applicant.

Reference symbol 36 designates a receiver/detector module, via which the measurement beam (receiving beam) reflected by the measuring object is detected.

In FIG. 3, a reference module 38 is arranged in the housing 2 transverse to the axis of rotation 30, which can be moved into the beam path for reference measurement.

Reference numbers 40 and 42 refer to a PC board and a motor board 40 or the measuring system 42 for controlling the laser head 34 and the detector module 36 and for evaluating the received measurement signals. Moreover, a connector board 44 for connections 26 also is accommodated in lower housing part 4.

As mentioned above, these assemblies are substantially arranged next to each other in a horizontal direction, so that only little installation space is required in the vertical direction (vertical to the floor space).

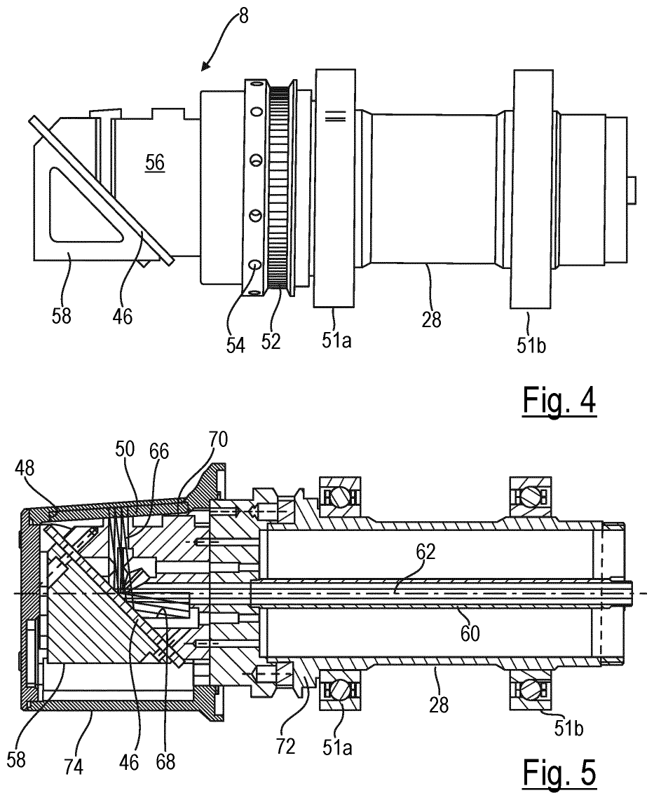

FIG. 4 shows a detailed representation of the deflection unit 8 with the hollow spindle 28 and its bearing 51a, 51b, which can be executed as a ball bearing. The in the figure right end section of hollow spindle 28 is then followed by the laser head 34 described above. Reference symbol 52 indicates a toothed rim that is in operative connection with a toothed belt of the drive. The recesses adjacent to the toothed rim 52 are balancing holes 54, which are utilized for balancing the hollow spindle 28. The in FIG. 4 left end section of deflection unit 8/hollow spindle 28 shows the beam guide 56 known per se, which is attached to the hollow spindle 28. In accordance with the disclosure, this beam guide 56 and thus the hollow spindle 28 supports the deflection mirror 46, which in the example shown is set at 45° to the horizontal. On the side of the deflection mirror 46 facing away from the beam guide 56, a counterweight 58 is arranged, which is designed for optimum balancing of the arrangement. The counterweight 58 is fixed, for example, through the deflection mirror 46 to the beam guide 56.

This can be seen, for example, from the sectional view in FIG. 5, which shows the hollow shaft 28, through the interior of which a tube 60 extends, along which the measurement beam 62 is guided from the laser head 34 towards the deflection mirror 46 through the hollow spindle 28. The measurement beam 62 is then deflected by the deflection mirror 46 in the direction of the outlet window 48, which, in the example shown, is covered by the protective glass (aperture glass) 50. This is arranged on rotor housing 74. In the example shown, the rotor housing 74 covers the counterweight 58, the deflection mirror 46 and the beam guide 56.

Due to the roughness of the protective glass 50 and in the case it is dirty, stray light 66 is reflected back in the direction of the deflection mirror 46 and there is deflected in the direction of beam guide 56. As explained initially, this proportion of stray light falsifies the measurement result in conventional scanners. This is prevented, in accordance with the disclosure, by the fact that in the area of the beam guide 56 which is exposed to the stray light, at least one pocket 68 is formed, which is aligned with respect to the stray light 66 in such a way that the stray light 66 is reflected into the pocket 68, thereby reflecting the stray light 66 between the protective glass 50 and the pocket(s) 68, so that the stray light 66 (the back reflection) tails off.

The stray light 66 is reduced further since, in the example in accordance with the disclosure, the protective glass 50 is supported on a support 70 of beam guide 56 via a black O-ring seal 69 or the like.

For the effective reduction of stray light, the at least one pocket 68 is provided with a coating reducing reflection, preferably with a black anti-reflective coating. Such coatings are known on the market, so that further indications are unnecessary.

In the illustrated example, the beam guide 56 is screwed to a front flange 72 of the hollow spindle 28, wherein—as mentioned above—the deflection mirror 46 is held between the beam guide 56 and the counterweight 58.

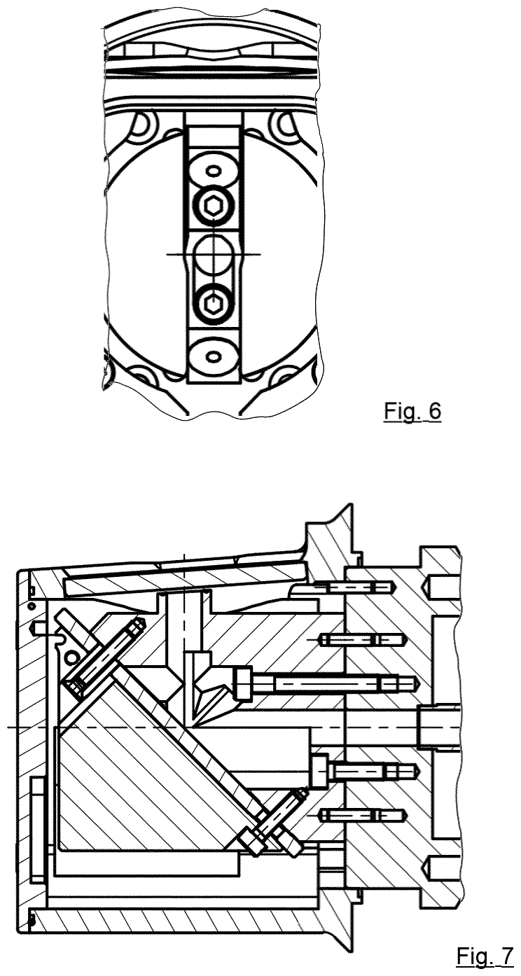

FIG. 6 shows the front view of an inclined end face 76 of the beam guide. In this view, it is to be recognized quite clearly that the beam guide 56 is plate-shaped, the beam path exiting or entering via the inclined end face 76 facing the deflection mirror 46. As illustrated by means of FIG. 5, the measurement beam 62 emitted by the laser head 34 is guided via the tube 60 through the hollow spindle 28 and is then guided via an axial bore 68 of the beam guide 56 in the direction of the deflection mirror 46. In the view according to FIG. 6, the latter is not visible. Due to the plate-shaped/web-shaped structure of the beam guide 56 and the front flange 72 of a diagonal web 84, the measurement beams reflected by the target object pass through the outlet window 48 and the protective glass 50 and enter the deflection unit 8 and are then deflected by the deflection mirror 46 in the direction of the detector module 36, the reflected measurement beams then being guided along the interior 80 of the hollow spindle 28 that encompass the tube 60 (FIG. 7).

In the illustration according to FIG. 6, above and below the axial bore 78, two screws 82 (only one is marked with a reference sign) are visible, via which the beam guide 56 is screwed to the front flange 84. This is shown quite clearly in the sectional view according to FIG. 7. For exact positioning, dowel pins 86 also are provided. The aforementioned pockets 68 for minimization of the proportion of stray light are arranged in the area of the beam guide 56, along which the measurement beam is guided to the deflection mirror 46 or to the outlet window 48. As can be seen in the illustration in FIG. 7, the measurement beam 62 is guided via a measurement beam bore 88 of the beam guide 56 in the direction of the protective glass 50, the axis of which is arranged at right angles to the axis of the tube 60 and the axial bore 78 arranged coaxially thereto. The indicated pockets 68 are preferably located in the transition region between the axial bore 78 and the measurement beam bore 88 of beam guide 56.

In principle, these pockets 68 are radial extensions of measurement beam bore 88 and axial bore 78, the radial extensions with regard to geometry being laid out such that the stray light is “captured” in the manner described above. Specifically, in the illustrated example, radial extensions are provided that are preferably arranged asymmetrically with respect to the beam guiding axis of beam guide 56, which in the illustration according to FIG. 7 are designated with reference signs 68a, 68b, 68c, 68d, 68e. In the illustration according to FIG. 7, a large number of cutting edges set at an angle to one another are visible, of which merely one cutting edge 90 is provided with a reference symbol. This means that the pockets 68 in part are cylindrical and in part are butted or formed as radial extensions, “tailing off” of the proportion of stray light substantially being caused by the inclined peripheral walls of these pocket regions.

As can moreover be seen from FIG. 7, some of the pockets 68a, 68b end in screw bores 92a, 92b, into which screws 82 for fastening the beam guide 56 on front flange 72 are inserted. In principle, the pockets 68 then form extensions of the screw holes 92 that are required anyway, so that the manufacturing effort for the production of those pockets is minimal.

As explained initially, the circumferential walls of the pockets 68 (68a, 68b, 68c, 68c, 68e) are coated with an anti-reflective-paint or other coating that reduces reflection, so that the diffuse stray light is reliably “swallowed”.

As can moreover be seen from the illustrations according to FIGS. 5 and 7, also the counterweight 58 is executed in an approximately plate-shaped manner and extends, as it were, in extension of beam guide 56. The counterweight 58 likewise is connected to the beam guide 56 via a plurality of screws 94. The axis of these screws 94 is perpendicular to the inclined end face 76. In the illustration according to FIG. 6, the heads of screws 94 are visible.

It can be recognized that in the deflection mirror 46, in the region of screws 94, which are arranged on a common pitch circle diameter, a through hole 96 is respectively provided that is penetrated by the respective screw 94, so that they do not come into threaded engagement with the screws 94. Accordingly, due to the screw connection of counterweight 58 with beam guide 56, the deflection mirror 46 is clamped between the two components.

As explained initially, the rotor housing with outlet window 48 and the protective glass 50 is screwed to front flange 84, the front flange 84, for positioning a location, being partially inserted into a recess 98 of rotor housing 74. For cleaning of the protective glass 50, the rotor housing 74 thus can be removed very easily without changing the relative position of the deflection mirror 46 with respect to the beam guide 56. As explained initially, this is a significant advantage vis-à-vis conventional solutions, where the deflection mirror is fixed to rotor housing 74.

For minimizing the moment of inertia and the overall weight, the mirror 46 is not made of aluminum in the conventional manner, but of a lighter material such as silicon carbide. Furthermore, the mirror 46 is executed with a substantially smaller wall thickness than a conventional aluminum mirror.

Disclosed is a 2D laser scanner, in which a deflection mirror is held on a beam guide supported by a hollow spindle.

### LIST OF REFERENCE SYMBOLS

1 Laser scanner
2 Housing
4 Lower housing part
6 Housing cover
8 Deflection unit
10 Flat portion
12 Support rib/feet
14 End face
16 End face
18 Lateral surface
20 Lateral surface
22 Base area
24 Base area
26 Connections
28 Spindle/hollow spindle
30 Axis of rotation
32 Motor
34 Laser head
36 Detector module
38 Reference module
40 PC/motor board
42 Measurement system
44 Connector board
46 Deflection mirror
48 Outlet window
50 Protective glass
51a, 51b Bearing
52 Toothed rim
54 Balancing holes
56 Beam guide
58 Counterweight
60 Tube
62 Measurement beam
66 Stray light
68 Pocket
69 Seal
70 Support
72 Front flange
74 Rotor housing
76 Inclined end face
78 Axial bore
80 Interior
82 Screw
84 Diagonal web
86 Dowel pin
88 Measurement beam bore
90 Cutting edge
92 Screw bore
94 Screw
96 Through-hole
98 Recess

What is claimed is:

1. A laser scanner comprising a laser head for emitting a measurement beam of a rotating deflection unit driven by a drive for deflecting the measurement beam in a direction of a measuring object, a detector module for detecting a reception/measurement beam reflected by the measuring object, and a control and evaluation unit for signal processing, the rotating deflection unit having a hollow spindle, which carries a beam guide to which a deflection mirror is associated for deflecting the reception/measurement beam in the direction of or from an outlet window held on a rotor housing, wherein the deflection mirror is fixed to the beam guide or to the hollow spindle.

2. The laser scanner according to claim 1, wherein the deflection mirror is located between the beam guide and a counterweight connected to the beam guide.

3. The laser scanner according to claim 2, wherein fasteners of the counterweight pass through the deflection mirror.

4. The laser scanner according to claim 1, wherein the deflection mirror is located on an inclined end face of the beam guide.

5. The laser scanner according to claim 2, wherein the rotor housing encompasses the deflection mirror, the beam guide and the counterweight at least in sections and is attached to a front flange of the hollow spindle.

6. The laser scanner according to claim 2, wherein the counterweight and the beam guide are plate- or web-shaped.

7. The laser scanner according to claim 5, wherein the front flange carries drive means.

8-13. (canceled)

14. The laser scanner according to claim 7, wherein the drive means is a toothed rim.

15. The laser scanner according to claim 6, wherein the rotor housing encompasses the deflection mirror, the beam guide and the counterweight at least in sections and is attached to a front flange of the hollow spindle, and wherein the front flange carries drive means.

16. The laser scanner according to claim 14, wherein the drive means is a toothed rim.

17. The laser scanner according to claim 1, wherein pockets that lie in a stray light beam path are arranged on the beam guide for minimizing stray light.

18. The laser scanner according to claim 1, wherein the deflection mirror is located on an inclined end face of the beam guide, wherein at least one pocket is formed on the beam guide, wherein the at least one pocket is arranged in a stray beam path, wherein the at least one pocket is arranged on the beam guide for minimizing stray light, and wherein the at least one pocket opens into an inclined end face of the beam guide.

19. The laser scanner according to claim 17, wherein at least one pocket opens into a screw bore.

20. The laser scanner according to claim 17, wherein the pockets are provided with a reflection-reducing coating.

21. The laser scanner according to claim 1, wherein in a region between a protective glass of the outlet window and the beam guide a seal is provided, along which the outlet window rests.

22. The laser scanner according to claim 1, wherein the deflection mirror consists of a material with a lower specific weight than aluminum.

23. The laser scanner according to claim 22, wherein the deflection mirror consists of silicon carbide.
